(19) United States
(12) Patent Application Publication
(10) Pub. No.: US 2021/0153645 A1
(43) Pub. Date: May 27, 2021

(54) FOLDAWAY SHELVING AND END PANEL FOR FOLDAWAY SHELVING

(71) Applicant: Ranger Design, Montreal (CA)

(72) Inventors: Gary Beere, Montreal (CA); Surjit Singh, Montreal (CA)

(21) Appl. No.: 17/105,922

(22) Filed: Nov. 27, 2020

Related U.S. Application Data
(60) Provisional application No. 62/941,546, filed on Nov. 27, 2019.

(51) Int. Cl. A47B 43/00; B60N 3/00; A47B 96/02; A47B 96/06; A47B 46/00

(52) U.S. Cl. CPC A47B 43/00; B60N 3/002; A47B 96/025; A47B 2220/0036; A47B 46/005; A47B 2220/0069; A47B 96/061

(57) ABSTRACT

The foldaway shelving unit comprises at least one shelf spaced from a floor of the vehicle. The at least one shelf is moveable between a foldout position and a stored position. At least one end panel connects the at least one shelf to at least one support. The at least one end panel includes a mounting bracket and a mounting arm. The mounting bracket connects to the at least one shelf and the mounting arm connects to the at least one support. A hinge allows the mounting bracket to rotate between the foldout position and the stored position. The mounting bracket has a first stopping surface and a second stopping surface each spaced from one another. A stopper extends outwardly from the mounting bracket for engaging the first stopping surface in the foldout position and for engaging the second stopping surface in the stored position.

### CROSS-REFERENCE TO RELATED APPLICATIONS

This application claims the benefit of U.S. Provisional Application Patent Ser. No. 62/941,546, filed on Nov. 27, 2019, the entire disclosure of which is hereby incorporated herein by reference in its entirety.

### BACKGROUND OF THE INVENTION

### 1. Field of the Invention

The present invention generally relates to foldaway shelving.

### 2. Description of the Prior Art

Foldaway shelving is generally known in the art for providing a space-saving storage options attached to a structure, such as a building or a vehicle. Typically, the shelving shelves spaced above the ground or floor and supported by upright posts. The shelves have a pivotable connection to the upright posts that allow the shelves to move between a foldout position and a stored position. At least one cable connects the shelves to the vehicle wall or the upright posts to support the shelves in the foldout position. The cord, cable, or other hanging hinged member takes up space in both the foldout position and the stored position, but also prevents clear access for the user to place a load on the shelf. The shelves typically cannot share a common upright post in a side-by-side configuration because the pivotable connections of the shelves interfere with one another. Thus, there is a demand for a foldaway shelving unit that allows the shelves to be side-by-side and provides clear access for a user to place the load on the shelves.

### SUMMARY OF THE INVENTION

The present invention provides foldaway shelving that is easy to assemble. The present invention also provides foldaway shelving that is simple to adjust. Further, the present invention provides foldaway shelving that allows shelves to be easily installed side-by-side to a common support.

It is one aspect of the present invention to provide a foldaway shelving unit for attachment within a vehicle. The foldaway shelving unit comprises at least one shelf spaced from a floor of the vehicle for supporting a load on the at least one shelf in a foldout position of the foldaway shelving unit. The at least one shelf is moveable between the foldout position and a stored position. At least one support extends upwardly from the floor for supporting the at least one shelf. At least one end panel connects the at least one shelf to the at least one support. The at least one end panel includes a mounting bracket and a mounting arm. The mounting bracket connects to the at least one shelf and the mounting arm connects to the at least one support. A hinge extends between the mounting bracket and the mounting arm to allow the mounting bracket to rotate between the foldout position and the stored position. The mounting bracket has a first stopping surface and a second stopping surface each spaced from one another. A stopper extends outwardly from the mounting bracket for engaging the first stopping surface in the foldout position and for engaging the second stopping surface in the stored position.

It is another aspect of the present invention to provide a foldaway shelving unit for attachment within a vehicle. The foldaway shelving unit comprises a first shelf and a second shelf disposed side-by-side, each spaced from a floor of the vehicle for supporting a load on each of the first shelf and the second shelf in a foldout position of the foldaway shelving unit. Each of the first shelf and the second shelf is moveable between the foldout position and a stored position. A common support extends upwardly from the floor for supporting the first shelf and the second shelf. A first end panel connects the first shelf to the common support. A second end panel connects the second shelf to the common support. Each of the first end panel and the second end panel includes a plurality of tabs spaced from one another by at least one notch. The plurality of tabs of the first end panel mesh with the plurality of tabs of the second end panel. The plurality of tabs of the first end panel engage the at least one notch of the second end panel. The plurality of tabs of the second end panel engage the at least one notch of the first end panel. At least one of the plurality of tabs receives a fastener for securing each of the first end panel and the second end panel to the common support.

It is another aspect of the present invention to provide an end panel for a shelf of a foldaway shelving unit. The end panel comprises a mounting bracket and a mounting arm. The mounting bracket connects to the shelf. The mounting arm connects to a support of the foldaway shelving unit. A hinge extends between the mounting bracket and the mounting arm to allow the mounting bracket to rotate between a foldout position and a stored position. The mounting bracket includes a lip for supporting the shelf and an upper rear portion spaced from the lip. A first stopping surface is disposed on a lower rear portion of the lip. A second stopping surface is disposed on the upper rear portion of the mounting bracket. A stopper extends outwardly from the mounting bracket for engaging the first stopping surface in the foldout position and for engaging the second stopping surface in the stored position. The end panel includes a securing portion of the mounting arm. The securing portion includes a plurality of tabs spaced from one another by at least one notch. The plurality of tabs receives a plurality of fasteners to secure the end panel to the support.

### BRIEF DESCRIPTION OF THE DRAWINGS

FIG. 1 is a perspective view of the foldaway shelving in the foldout position according to one embodiment of the present invention;

FIG. 2 is a perspective view of a shelf in the foldout position according to one embodiment of the present invention;

FIG. 3 is a perspective view of a shelf in the stored position according to one embodiment of the present invention;

FIG. 4 is a side view of the foldaway shelving in the foldout position according to one embodiment of the present invention;

FIG. 5 is a perspective fragmentary view of a support and a threaded plate according to one embodiment of the present invention;

FIGS. 6 & 7 are a perspective views of an end panel in the foldout position according to one embodiment of the present invention;

FIG. 8 is a perspective view of an end panel with a mounting bracket of the end panel removed according to one embodiment of the present invention;

FIG. 9 is a perspective view of an end panel in the stored position according to one embodiment of the present invention;

FIG. 10 is a side view of an end panel in the stored position according to one embodiment of the present invention;

FIG. 11 is a perspective view of the foldaway shelving unit with shelves disposed side-by-side according to one embodiment of the present invention; and

FIG. 12 is a perspective view of a pair of end panels attached to a common support of the foldaway shelving unit according to one embodiment of the present invention.

### DESCRIPTION OF THE ENABLING EMBODIMENT

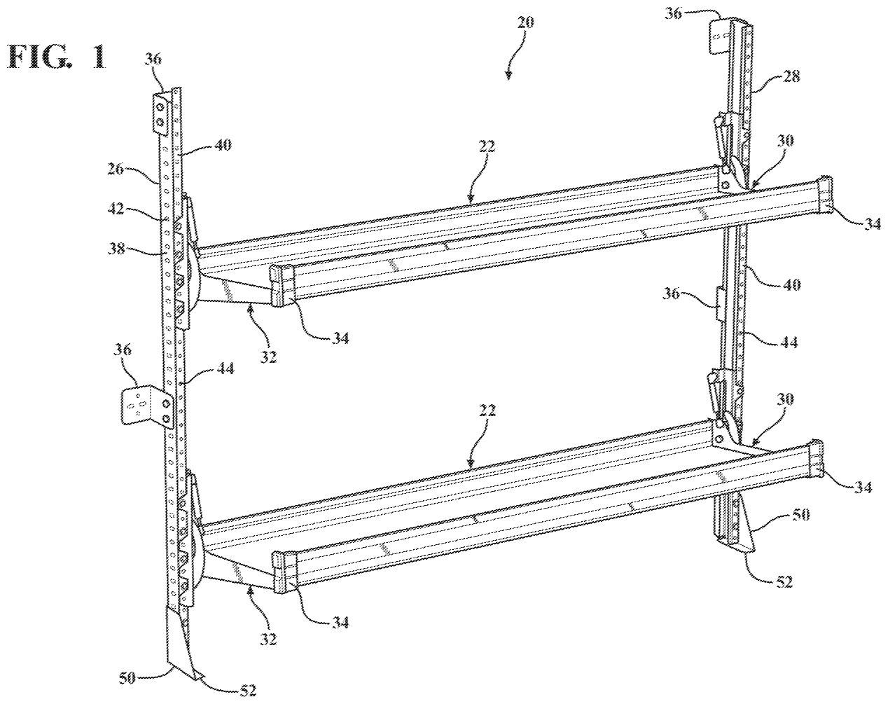

Referring to the Figures, wherein like numerals indicate corresponding parts throughout the several views, foldaway shelving constructed in accordance with one embodiment of the present invention is generally shown in FIG. 1.

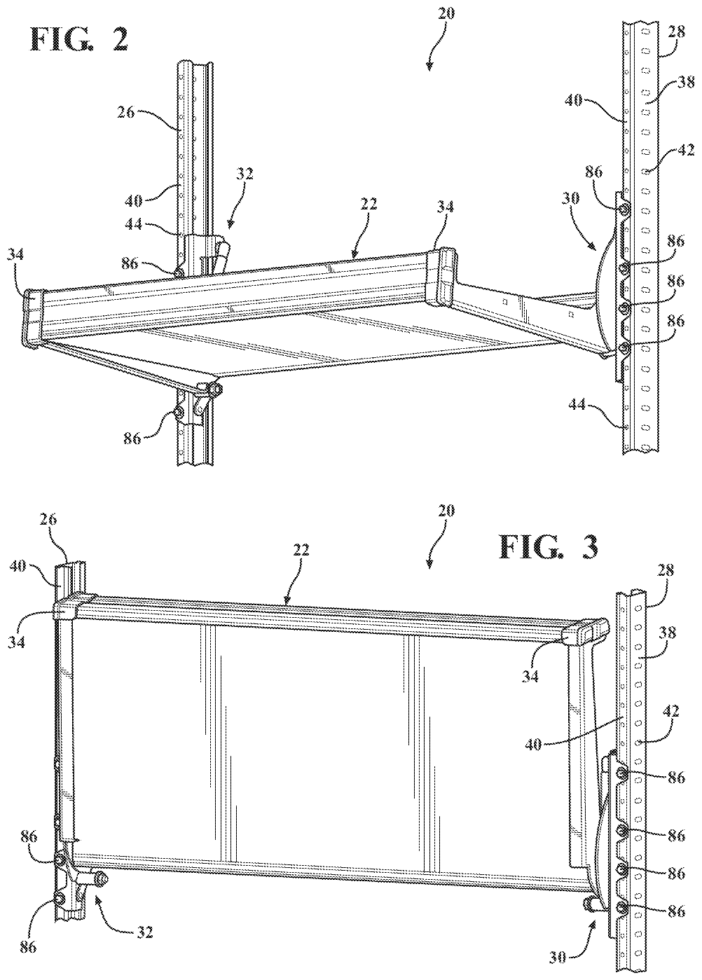

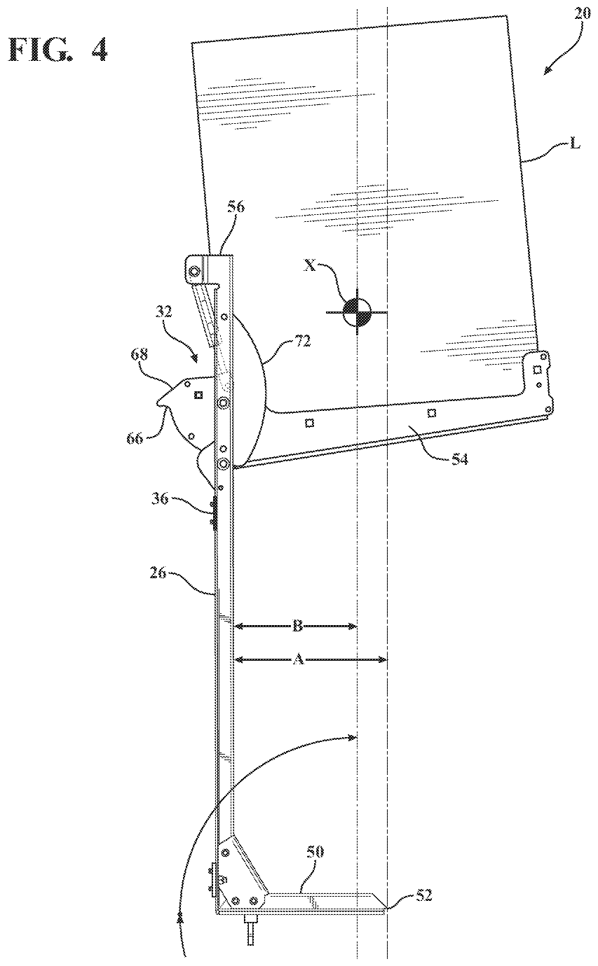

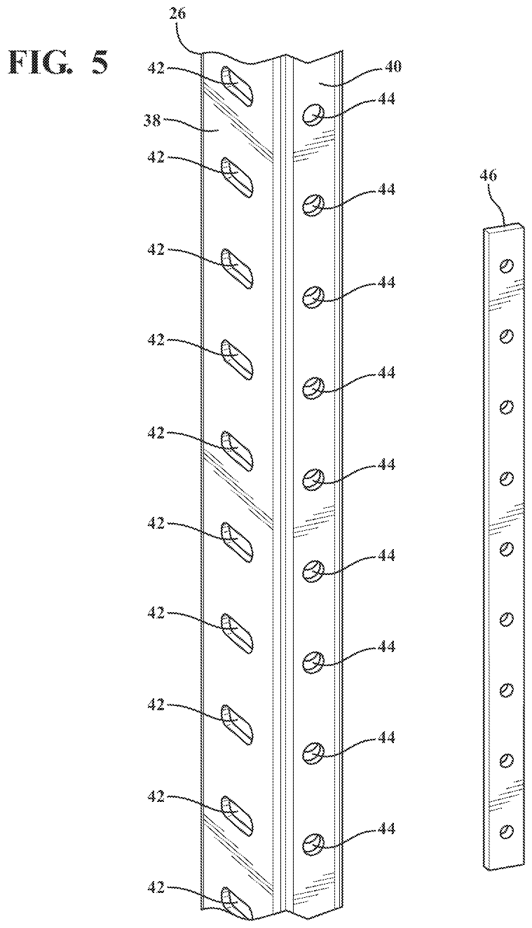

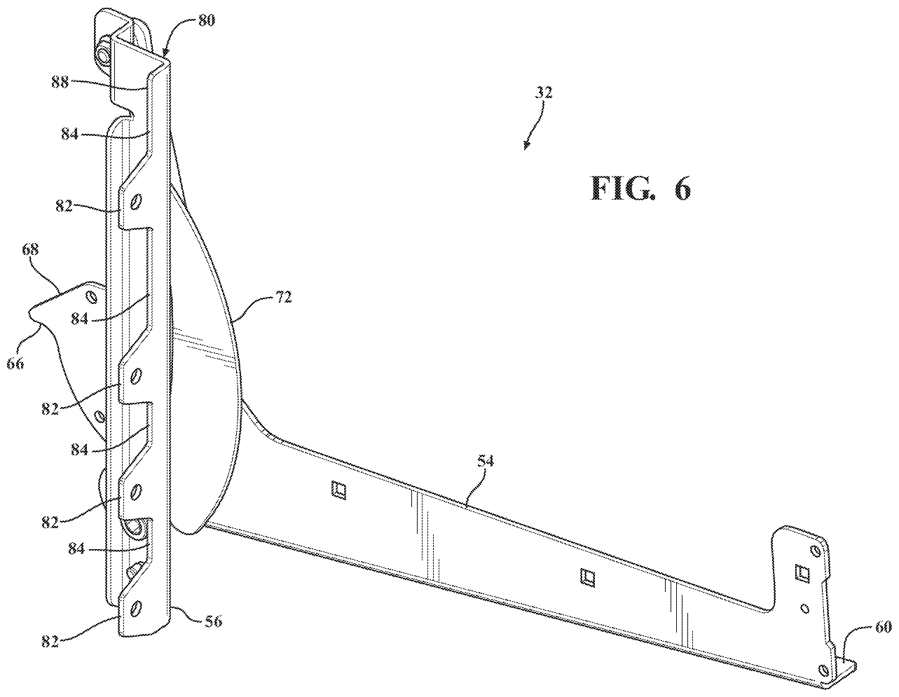

With reference to FIGS. 1-5, the foldaway shelving of the present invention may be a foldaway shelving unit 20 for attachment within a vehicle. The foldaway shelving unit 20 includes at least one shelf 22, 24, spaced from a floor of the vehicle, for supporting a load L on the at least one shelf 22, 24 in a foldout position of the foldaway shelving unit 20. The at least one shelf 22, 24 is moveable between the foldout position and a stored position. At least one support 26, 28, such as an upright post, extends upwardly from the floor for supporting the at least one shelf 22, 24. In some embodiments, the at least one support 26, 28 is a post, which can be made of various materials. The disclosed material is aluminum, however they could be made of steel or even plastic depending upon the loads to be placed on the at least one shelf 22, 24. At least one end panel 30, 32 connects the at least one shelf 22, 24 to the at least one support 26, 28. In some embodiments, the at least one end panel 30, 32 includes right and left pre-assembled end panels 30, 32. These end panels 30, 32 mount to each side of the shelves 22, 24 and connect the shelves 22, 24 to the support 26, 28. As illustrated, the end panels 30, 32 are screwed to the shelves 22, 24, but could be bolted, snap fit, or welded. Protective end caps 34 may also be disposed at the front end of the end panels 30, 32 as shown. Wall mounting braces 36 may be used to further secure the shelving 20, and further to secure the support 26, 28 to the vehicle sidewalls.

The supports 26, 28 are mounted to the floor of the vehicle by cantilevered feet 50. In some embodiments, the cantilevered foot extends to a foot end 52 laterally spaced from the at least one support 26, 28 by a first distance A. In the foldout position, a center of gravity X of the at least one shelf 22, 24 is laterally spaced from the at least one support 26, 28 by a second distance B. The first distance A may be greater than the second distance B. In some embodiments, when the load L is on the at least one shelf 22, 24, the center of gravity X of the loaded shelf 22, 24 relative to the position of the foot end 52 allows transfer of the static load to the vehicle floor. In addition, the center of gravity X of the loaded shelf relative to the position of the foot end 52 also may also convert dynamic load, which is typically on the vehicle wall fasteners 86, from a tension load to a shear load to protect the integrity of the vehicle structure.

The supports 26, 28 of the disclosed embodiment have a side surface 38 and a front surface 40. The surfaces 38, 40 include openings 42, 44 for attachment of the braces 36 and attachment of the end panels 30, 32. As illustrated, the side surface 38 has oval openings 42, and the front surface 40 has circular openings 44. These give adjustability in mounting at different positions in the vehicle. The oval openings 42 are for receipt of the wall mount brace bolts. The circular openings 44 are for receipt of the preassembled end panel 30, 32 bolts. As illustrated, a threaded plate 46 may be provided for easier mounting of the end panels 30, 32. The threaded plate 46 is an elongated plate 46 with a series of threaded openings 48 for receipt of fasteners 86, such as bolts, of the end panel 30, 32.

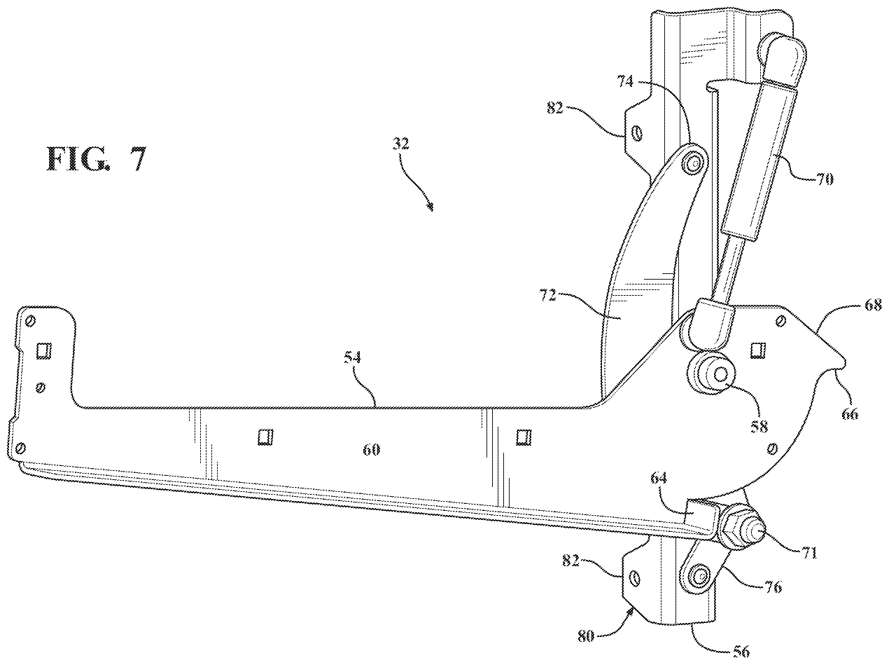

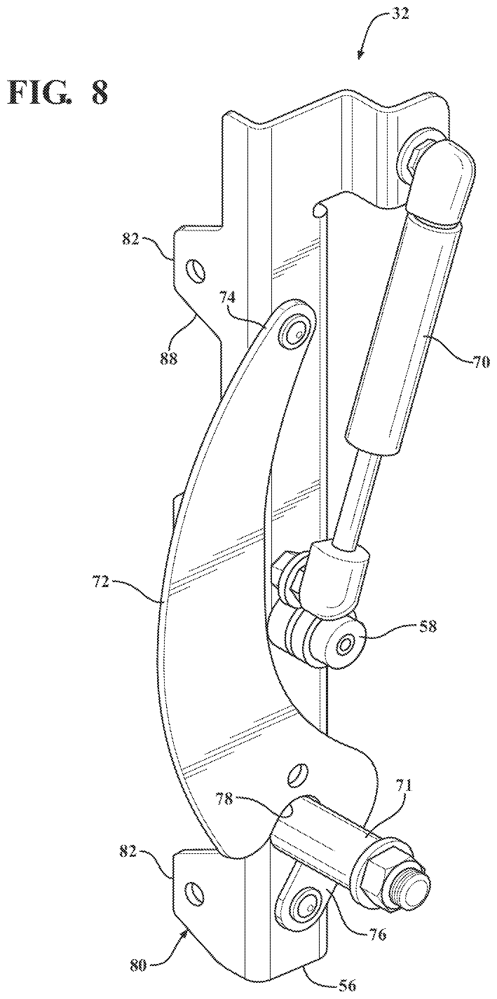

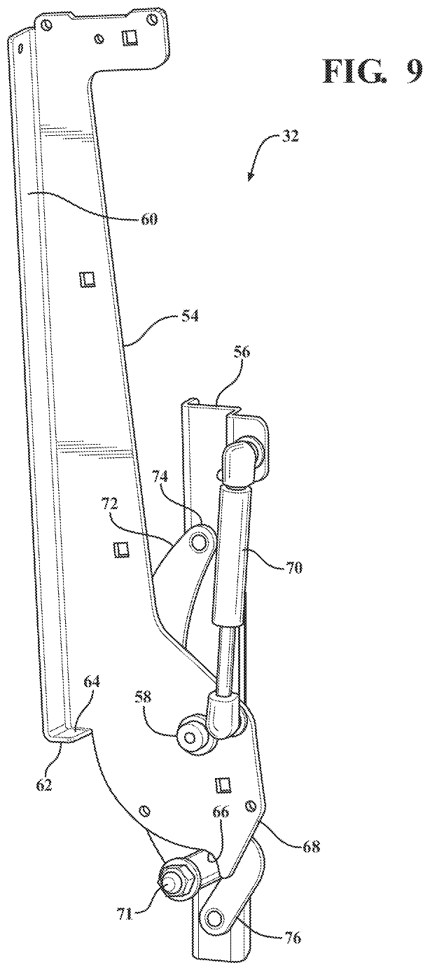

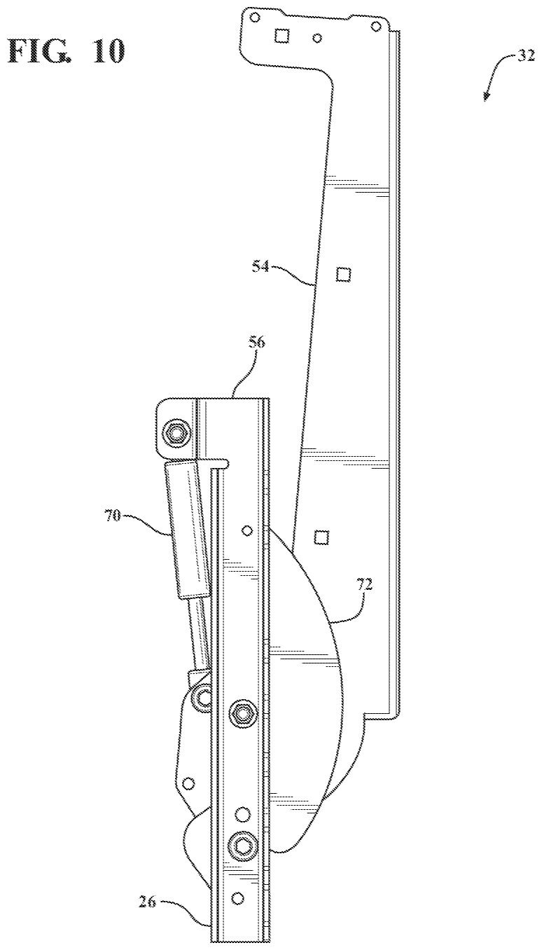

As illustrated in FIGS. 6-10, each end panel 30, 32 includes a mounting bracket 54 and a mounting arm 56. The mounting bracket 54 connects to the at least one shelf 22, 24 and pivotally connects to at least one support 26, 28 of the foldaway shelving unit 20 or the mounting arm 56 of the end panel 30, 32. The mounting arm 56 connects to the at least one support 26, 28. A hinge 58 extends between the mounting bracket 54 and the mounting arm 56 to allow the mounting bracket 54 to rotate between the foldout position and the stored position. In some embodiments, the hinge 58 is a pivot pin having a cylindrical shape. The mounting bracket 54 includes a lip 60 for supporting the shelf 22, 24 and an upper rear portion 68 spaced from the lip 60. A first stopping surface 62 is disposed on a lower rear portion 64 of the lip 60. A second stopping surface 66 is disposed on an upper rear portion 68 of the mounting bracket 54.

The end panel 30, 32 includes a biasing member 70 extending between the mounting bracket 54 and the mounting arm 56 to bias the shelf 22, 24 in either the foldout position or the stored position. The biasing member 70 facilitates the raising and lowering of the shelf 22, 24. In some embodiments, the biasing member 70 is a gas shock, or damper, to dampen movement of the at least one shelf 22, 24 between the foldout position and the stored position. The end panels 30, 32 further include a stopper 71 extending outwardly from the mounting bracket 54 for engaging the first stopping surface 62 in the foldout position and for engaging the second stopping surface 66 in the stored position. In other words, the stopper 71 is provided to stop the shelf 22, 24 in the fully up (stored) and fully down (foldout) positions. In some embodiments, the stopper 71 of the disclosed embodiment is a bolt with a spacer over the bolt. The first stopping surface 62 contacts the stopper 71 in the fully down position, and the second stopping surface 66 contacts the stopper 71 in the fully raised position. The stopper 71 also transfers the load placed upon the shelves 22, 24 to the post. In some embodiments, the foldaway shelving unit 20 does not have a cord, cable, or other hanging support hinge extending between the at least one shelf 22, 24 and either the support 26, 28, the at least one end panel 30, 32, or the vehicle wall to support the at least one shelf 22, 24 in the foldout position.

A guard 72 extends from the mounting arm 56 adjacent the hinge 58 to provide clearance between the guard 72 and the mounting arm 56. In some embodiments, a minimum clearance between the guard 72 and the mounting arm 56 is at least 0.5 inches in the stored position. The guard 72 has an arcuate shape between a top 74 of the guard 72 and a bottom 76 of the guard 72 and defines a groove 78 adjacent the bottom 76 for receiving the stopper 71. The pinch guard 72 protects the user by isolating the areas where a user can place their hand while using the shelf 26, 28 that could otherwise result in pinching of the user's fingers or hands.

The mounting arm 56 of the at least one end panel 30, 32 includes a securing portion 80 for attaching to the post. The securing portion 80 including a plurality of tabs 82 spaced from one another by at least one notch 84. The plurality of tabs 82 receive a plurality of fasteners 86, or bolts, to secure the end panel 30, 32 to the support. In some embodiments, the at least one support 26, 28 and the securing portion 80 sandwich the threaded plate 46, and bolts are threaded through the tabs 82 to lock the at least one support 26, 28, the threaded plate 46, and the securing portion 80 together.

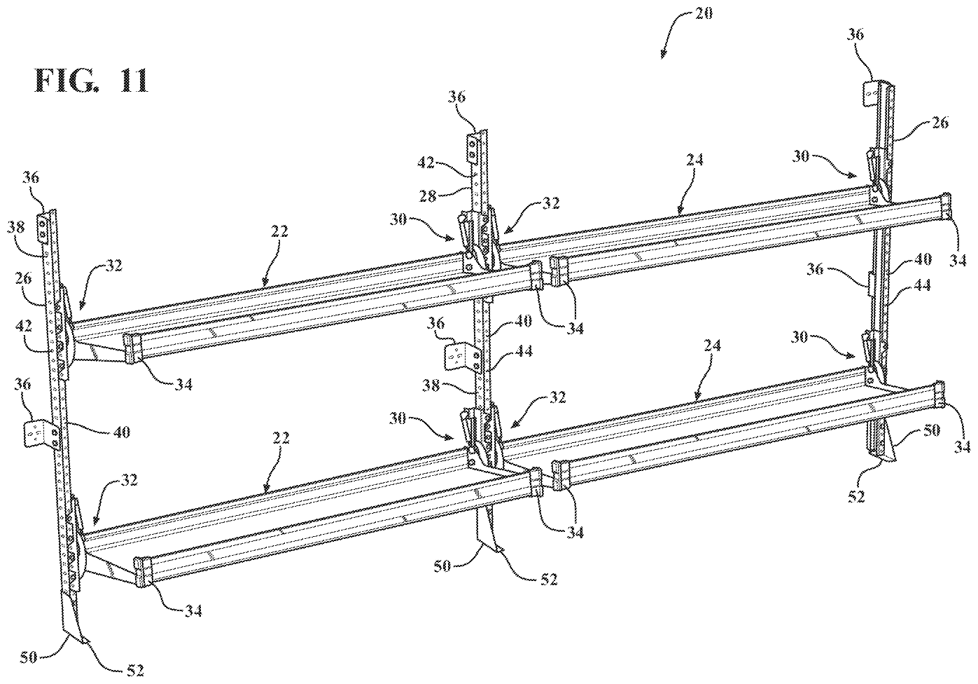

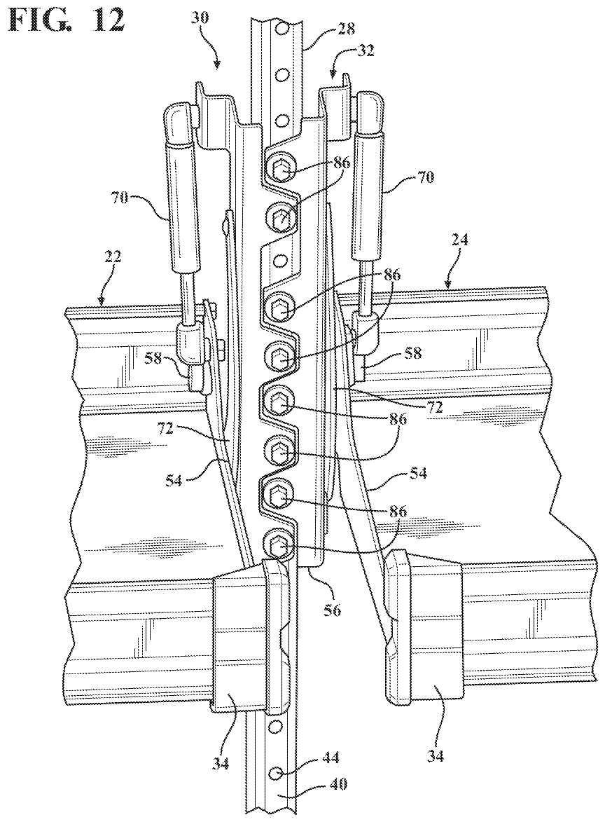

As illustrated in FIGS. 11-12, the at least one shelf 22, 24 may include a first 22 and a second shelf 24 disposed side-by-side with one another. In one embodiment, each of the first and second shelves 22, 24 are spaced from a floor of the vehicle for supporting a load L on each of the first shelf 22 and the second shelf 24 in a foldout position of the foldaway shelving unit 20. The at least one support 26, 28 may include a common support 28 extending upwardly from the floor for supporting the first shelf 22 and the second shelf 24. The at least one end panel 30, 32 includes a first end panel 30, 32 and a second end panel 30, 32. In other words, the first shelf 22 and the second shelf 24 are each connected to a common support 28 of the at least one support 26, 28. The first end panel 30, 32 connects the first shelf 22 to the common support 28 and the second end panel 30, 32 connects the second shelf 24 to the common support 28.

The plurality of tabs 82 of the first end panel 30, 32 engages the at least one notch 84 of the second end panel 30, 32 adjacent the common support 28, and the plurality of tabs 82 of the second end panel 30, 32 engages the at least one notch 84 of the first end panel 30, 32 adjacent the common support 28 as well. Accordingly, the plurality of tabs 82 of the first end panel 30, 32 mesh with the plurality of tabs 82 of the second end panel 30, 32. At least one of the plurality of tabs 82 receives a fastener 86 for securing each of the first end panel 30, 32 and the second end panel 30, 32 to the common support 28. In some embodiments, the foldaway shelving unit 20 does not have a cord extending between either of the first shelf 22 and the second shelf 24 and either of the common support 28, the first end panel 30, 32, the second end panel 30, 32, and the vehicle wall to support each of the first shelf 22 and the second shelf 24 in the foldout position.

In some embodiments, the plurality of tabs 82 and the at least one notch 84 of each of the at least one end panel 30, 32 create a zigzag shape along an edge 88 of the securing portion 80 of the mounting arm 56. The zigzags mate with the zigzags of an adjacent mounting arm 56. This allows adjoining shelves 22, 24 to be mounted adjacent one another on the same post and allows the post to have a thinner overall profile. In other words, in some embodiments, the mounting arms 56 mate. One mounting arm 56 is for the right-hand side, and the other is for the left-hand side, i.e. they are left and right hand specific. The left- and right-hand zigzag end panels 30, 32 are offset to allow interlocking. This allows the shelves 22, 24 to be the same height even though the mounting hole positions on the supports 26, 28 are different. In the illustrated embodiment, there is a greater distance between the topmost tab 82 and the next tab 82, which may allow for a longer plate 46 with greater strength and load distribution.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A foldaway shelving unit for attachment within a vehicle, said foldaway shelving unit comprising:
at least one shelf spaced from a floor of said vehicle for supporting a load on said at least one shelf in a foldout position of said foldaway shelving unit, with said at least one shelf being moveable between said foldout position and a stored position;
at least one support extending upwardly from said floor for supporting said at least one shelf;
at least one end panel connecting said at least one shelf to said at least one support;
said at least one end panel including a mounting bracket and a mounting arm, wherein said mounting bracket connects to said at least one shelf and said mounting arm connects to said at least one support;
a hinge extending between said mounting bracket and said mounting arm to allow said mounting bracket to rotate between said foldout position and said stored position;
said mounting bracket having a first stopping surface and a second stopping surface each spaced from one another; and
a stopper extending outwardly from said mounting bracket for engaging said first stopping surface in said foldout position and for engaging said second stopping surface in said stored position.

2. The foldaway shelving unit according to claim 1, wherein said foldaway shelving unit does not have a cord extending between said at least one shelf and either said support, said at least one end panel, or said vehicle wall to support said at least one shelf in said foldout position.

3. The foldaway shelving unit according to claim 1 further including a biasing member extending between said mounting bracket and said mounting arm to bias said at least one shelf in either said foldout position or said stored position.

4. The foldaway shelving unit according to claim 3 further including a guard extending from said mounting arm adjacent said hinge to provide a minimum clearance between said guard and said mounting arm of at least 0.5 inches in said stored position.

5. The foldaway shelving unit according to claim 4 wherein said guard has an arcuate shape between a top of said guard and a bottom of said guard, and wherein said guard defines a groove adjacent said bottom for receiving said stopper.

6. The foldaway shelving unit according to claim 1 further including a securing portion of said mounting arm, with said securing portion including a plurality of tabs spaced from one another by at least one notch; and
said plurality of tabs receiving a plurality of fasteners to secure said end panel to said at least one support.

7. The foldaway shelving unit according to claim 6 wherein said at least one end panel includes a first end panel and a second end panel and wherein said at least one shelf includes a first shelf and a second shelf disposed side-by-side and connected to a common support of said at least one support; and
wherein said first end panel connects said first shelf to said common support and said second end panel connects said second shelf to said common support, wherein said plurality of tabs of said first end panel engages said at least one notch of said second end panel adjacent said common support.

8. The foldaway shelving unit according to claim 1 wherein said hinge is a pivot pin spaced from said stopper.

9. A foldaway shelving unit for attachment within a vehicle, said foldaway shelving unit comprising:
a first shelf and a second shelf disposed side-by-side, each spaced from a floor of said vehicle for supporting a load on each of said first shelf and said second shelf in a foldout position of said foldaway shelving unit, with each of said first shelf and said second shelf being moveable between said foldout position and a stored position;
a common support extending upwardly from said floor for supporting said first shelf and said second shelf;
a first end panel connecting said first shelf to said common support and a second end panel connecting said second shelf to said common support, with each of said first end panel and said second end panel including a plurality of tabs spaced from one another by at least one notch;
wherein said plurality of tabs of said first end panel mesh with said plurality of tabs of said second end panel, with said plurality of tabs of said first end panel engaging said at least one notch of said second end panel, and with said plurality of tabs of said second end panel engaging said at least one notch of said first end panel; and
wherein at least one of said plurality of tabs receives a fastener for securing each of said first end panel and said second end panel to said common support.

10. The foldaway shelving unit according to claim 9, wherein said foldaway shelving unit does not have a cord extending between either of said first shelf and said second shelf and either of said common support, said first end panel, said second end panel, and said vehicle wall to support each of said first shelf and said second shelf in said foldout position.

11. The foldaway shelving unit according to claim 9 further including a biasing member extending between said mounting bracket and said mounting arm to bias each of said first shelf and said second shelf in either said foldout position or said stored position.

12. The foldaway shelving unit according to claim 10 further including a guard extending from said mounting arm adjacent said hinge to provide a minimum clearance between said guard and said mounting arm of at least 0.5 inches in said stored position.

13. The foldaway shelving unit according to claim 12 wherein said guard has an arcuate shape between a top of said guard and a bottom of said guard, and wherein said guard defines a groove adjacent said bottom for receiving said stopper.

14. The foldaway shelving unit according to claim 9 wherein said hinge is a pivot pin spaced from said stopper.

15. An end panel for a shelf of a foldaway shelving unit, said end panel comprising:
a mounting bracket and a mounting arm, wherein said mounting bracket connects to said shelf and said mounting arm connects to a support of said foldaway shelving unit;
a hinge extending between said mounting bracket and said mounting arm to allow said mounting bracket to rotate between a foldout position and a stored position;
said mounting bracket including a lip for supporting said shelf and an upper rear portion spaced from said lip;
a first stopping surface disposed on a lower rear portion of said lip;
a second stopping surface disposed on said upper rear portion of said mounting bracket;
a stopper extending outwardly from said mounting bracket for engaging said first stopping surface in said foldout position and for engaging said second stopping surface in said stored position;
a securing portion of said mounting arm, with said securing portion including a plurality of tabs spaced from one another by at least one notch; and
said plurality of tabs receiving a plurality of fasteners to secure said end panel to said support.

16. The end panel according to claim further 15 including a biasing member extending between said mounting bracket and said mounting arm to bias said shelf in either said foldout position or said stored position.

17. The foldaway shelving unit according to claim 15 further including a guard extending from said mounting arm adjacent said hinge to provide a minimum clearance between said guard and said mounting arm of at least 0.5 inches in said stored position.

18. The foldaway shelving unit according to claim 17 wherein said guard has an arcuate shape between a top of said guard and a bottom of said guard, and wherein said guard defines a groove adjacent said bottom for receiving said stopper.

19. The foldaway shelving unit according to claim 15 wherein said hinge is a pivot pin spaced from said stopper.
